(19) United States
(12) Patent Application Publication
(10) Pub. No.: US 2010/0017432 A1
(43) Pub. Date: Jan. 21, 2010

(54) SYSTEMS AND METHODS FOR COMMUNITY EXCHANGE

(75) Inventors: Raymer Shandel, Westlake Village, CA (US); Erin Mester, Westlake Village, CA (US); Abtin Rostamian, Westlake Village, CA (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: LifeSpeed Corporation, Calabasas, CA (US)

(21) Appl. No.: 12/505,181

(22) Filed: Jul. 17, 2009

Related U.S. Application Data
(60) Provisional application No. 61/081,663, filed on Jul. 17, 2008.

(51) Int. Cl. G06F 17/30

(52) U.S. Cl. 707/102; 707/E17.03

(57) ABSTRACT

Systems and methods for computer-based community networking to facilitate the trade and exchange of goods and/or services between registered users are disclosed. In the disclosed systems and methods, a first registered user affiliated with a set of one or more community groups searches for an invitation to buy or sell a good or a service, and in response to the search, the disclosed systems and methods return a list of one or more invitations comprising at least one invitation associated with a registered user that is affiliated with at least one community group of the first set of one or more community groups.

### PRIORITY

The present application claims priority to U.S. Provisional Application No. 61/081,663 filed on Jul. 17, 2008, the contents of which are hereby incorporated herein by reference in their entirety.

### FIELD

This disclosure relates generally to systems and methods for computerized community networking, particularly to facilitate the trade and exchange of goods and/or services between registered users affiliated with community groups.

### BACKGROUND

The availability of digital networks and advanced technology tools has made it possible to build computerized systems that hide the complexities of most complicated transactions. In recent years, websites have appeared on the Internet for selling or auctioning goods, and for facilitating the provision of specific services between buyers and sellers/service-providers. The merchandise auction and sale web sites are primarily global online marketplaces that facilitate trade between buyers and sellers—independent of any community affiliation or relationship between the buyer and seller. The websites that facilitate services are generally (a) online yellow pages providing contact information of merchants, professionals, contractors, and service providers; (b) finders or referral services that capture data about providers and make it available to buyers; and/or (c) “lead” sellers who capture data about potential buyers and their demands (i.e. sales “leads”) and sell the data to bidding sellers and service providers. The above-described systems do not provide a means for matching buyers and sellers based on any sort of community affiliation or relationship between the buyer and seller, they do not provide a comprehensive platform for buyers and sellers to exchange their goods and services, and they do not deliver a comprehensive toolset for people and companies that exchange goods and services to plan, organize, track, and manage their business activities in a documented, traceable, archived, and verifiable manner.

One known system having many of the aforementioned shortcomings is the system described in U.S. Pat. No. 5,758,328 titled Computerized Quotation System and Method. The system of the '328 patent lacks a central data repository, and it lacks user interfaces for participants to (i) establish an online presence and (ii) store facts and figures about qualifications, product qualities, and references. The system of the '328 patent also lacks simple user interfaces to enable individuals with ordinary computer knowledge to (i) enter textual, graphical, audio, and video contents for describing the goods and services being offered or pursued, or (ii) start and operate an online business of their own. The system of the '328 patent also lacks any means for matching buyers and sellers based on any sort of community affiliation or relationship between the buyer and seller, and the system of the '328 also lacks a means to enable participants to plan, organize, track, and process payments for transactions using a comprehensive user interface that lists active orders together with historical and archival data of prior activities. Instead, the '328 patent describes system and methods for manipulating a buyer's demand before broadcasting it as a Request For Quotation to groups of merchants, unknown to the buyer, who are chosen based on hidden internal filtering parameters. Additionally, the system lacks a traceable and verifiable method of documenting the exchanges between buyers and sellers.

The system described in U.S. Pat. No. 7,096,193 (Facilitating commerce among consumers and service providers by matching ready-to-act consumers and pre-qualified service providers) hides a seller's data, and uses a hierarchical interface to capture information about buyers and their needs. The system of the '193 patent uses an internal process to package and sell captured information as “leads” to multiple competing sellers such as contractors and/or service providers. As a result, a buyer may often receive calls from multiple sellers that the buyer does not know. To further frustrate matters, the sellers who purchased the “lead” may feel entitled to the buyer's business because the sellers have paid a fee for the buyer's “lead.” In addition to producing an undesirable buyer/seller relationship, the system of the '193 patent also lacks a central data repository, and it lacks user interfaces to enable buyers and sellers to establish an online presence for buying and selling goods and services without intrusion and manipulation of a middleman's unknown internal filtering mechanisms. The system of the '193 patent also lacks simple user interfaces that enable individuals with ordinary computer knowledge to (i) enter textual, graphical, audio, and video contents for describing the goods and services being offered or pursued, or (ii) start and operate an online business of their own. Also, the system of the '193 patent does not connect buying and selling parties based on any sort of community affiliation or relationship between the buyer and seller. Finally, the system of the '193 patent also lacks a comprehensive user interface that enables buyers and sellers to (i) plan, organize, track, and process payments for transactions, (ii) monitor active orders, (ii) review transaction histories, and (iii) access other information related to operating an online business.

### SUMMARY

Community exchange systems and methods for trading and exchanging goods and services between members of various community groups are disclosed.

Buyers and sellers may register with a community exchange system to become registered users of the community exchange system. As registered users, the buyers and sellers may use the community exchange system to exchange (i.e., buy and/or sell) goods and services with each other. Any person may become a registered user of the community exchange system simply by registering with the system.

The community aspect of the community exchange system is facilitated by the concept of community groups. To exchange goods and services according to the disclosed systems and methods, a registered user should be affiliated with at least one community group. A registered user may create a new community group, or a registered user may join an existing community group that may have already been created by another registered user.

Community groups may be based on any of sort of business interest, personal interest, religious interest, community interest, or any other interest that a registered user may decide to base a community group upon. For example, community groups can be based on the backgrounds, interests, and/or activities of registered users, such as business/industry groups, alumni groups, religious groups, sports fan clubs, or similar business/activity/interest-based community groups. Any registered user can create a community group for any for-profit or non-profit purpose.

There are many advantages to exchanging goods and services with other registered users in the same community group. For example, registered users in a given industry-based community group may have special skills, knowledge, or experience relevant to the particular community group's related industry. As a result, registered users can target their goods and services to a particular community group corresponding to an industry in which they have relevant experience. In the context of activity or interest-based community groups, registered users in a community group can patronize other registered users in the same community group to support other professionals having the backgrounds, interests, and/or activities corresponding to the community group. Exchanging goods and services with other registered users in the same community group may also have other advantages in different contexts.

In some instances, registered users who are affiliated with a particular community group may pledge a portion of their sales to the community group. Some community groups might use the pledged sales to fund marketing and advertising programs for the benefit of the community group's members. Other community groups might use the pledged sales to support a philanthropic cause associated with the community group, such as scientific research, the arts, education, scholarships, religious activities, or similar philanthropic causes associated with the community group. In this manner, the community group affiliations provide advantages to buyers, sellers, and their affiliated community groups.

To exchange (i.e. buy and/or sell) goods and services, registered users may create and post either (i) an “invitation to make an offer to sell” a good or service, or (ii) an “invitation to make an offer to buy” a good or service. In this manner, registered users who wish to buy a desired good or service can create and post an “invitation to make an offer to sell” the desired good or service, and registered users who wish to sell a particular good or service could create and post an “invitation to make an offer to buy” the particular good or service. Similarly, a registered user who wishes to buy a desired good or service could also search the community exchange system for an existing “invitation to make an offer to buy” the desired good or service, and a registered user who wishes to sell a particular good or service could search the community exchange system for an existing “invitation to make an offer to sell” the particular good or service.

A database of information associated with the community exchange system stores and maintains data related to the registered users of the system, data related to the community groups, data related to the community group affiliations, and data related to goods and services offered and pursued by the registered users. The database also stores and maintains transaction histories between registered users to allow registered users to keep records related to past transactions. The database also houses other information to facilitate the operation of the community exchange system as will be described in more detail below. In this manner, the database associated with the community exchange system enables registered users to, among other things, (i) create and post invitations to make offers to buy or sell goods and services, (ii) search for invitations to make offers to buy or sell goods and services, (iii) complete transactions for the purchase and/or sell of goods and services; and (iv) access transaction histories.

A method according to one embodiment may comprise maintaining a database of information on computer readable storage media, where the information comprises (i) a plurality of registered users, (ii) a plurality of community groups, wherein at least a portion of the registered users are affiliated with one or more community groups, and (iii) a plurality of invitations to make an offer to buy or sell a good or service, where each invitation is associated with at least one registered user. A search input comprising a request to buy or sell a good or service is received from a first registered user. The first registered user is affiliated with a first set of one or more community groups. Then, a list of one or more invitations is generated in response to the search input. The list of one or more invitations may be generated by one or more processors configured to search the database of information based at least in part on the search input. The list of one or more invitations comprises at least one invitation associated with a registered user that is affiliated with at least one community group of the first set of one or more community groups.

In some embodiments, each registered user may be associated with a set of user attributes, and each community group may be associated with a set of group attributes. In these embodiments, generating the list of one or more invitations may comprise searching the database of information based on the search input to generate a list of search results, and then filtering the list of search results based on one or more attributes selected from at least one of (i) the user attributes associated with the first registered user, and/or (ii) the group attributes associated with at least one community group of the first set of one or more community groups.

In other embodiments where each registered user is associated with a set of user attributes, and where each community group is associated with a set of group attributes, generating the list of one or more invitations may comprise generating a search query comprising the search input and at least one attribute selected from at least one of (i) the user attributes associated with the first registered user, and/or (ii) the group attributes associated with at least one community group of the first set of one or more community groups. Once the search query has been generated, the search query can then be used to search the database of information to generate the list of one or more invitations.

In some embodiments, at least one invitation of the list of one or more invitations may comprise information about at least one community group affiliation of the registered user associated with the at least one invitation.

Some embodiments may further comprise causing the list of one or more invitations to be displayed to the first registered user in a certain order. For example, the first registered user may specify one or more preferred community groups, and the list of one or more invitations may be displayed so that invitations associated with registered users who are affiliated with a preferred community group are displayed higher in the list than invitations associated with registered users who are not affiliated with a preferred community group. In another example, the first registered user may specify one or more preferred user attributes (described in more detail below), and the list of one or more invitations may be displayed so that invitations associated with registered users whose associated user attributes comprise at least one preferred user attribute are displayed higher in the list than invitations associated with registered users whose associated user attributes do not comprise at least one preferred user attribute. In yet another example, the first registered user may have an associated referral network, and the list of one or more invitations may be displayed so that invitations associated with registered users who are members of a referral network associated with the first registered user are displayed higher in the list than invitations associated with registered users who are not members of the referral network associated with the first registered user.

Some embodiments may further comprise receiving a selection input from the first registered user. The selection input may indicate one invitation selected from the list of one or more invitations, and the selected invitation may be associated with a second registered user. After receiving the selection input, one or more electronic communications between the first and second registered users may be processed during which the first and second users may agree to one or more terms and/or conditions related to the selected invitation. Then, an order confirmation based on indications received from the first and second registered users may be generated. The order confirmation may reflect one or more terms and/or conditions mutually agreed to by the first and second registered users.

A system according to one embodiment may comprise a computer readable storage media and a set of one or more processors. The computer readable storage media may be configured to store a database of information, and the database of information may comprise (i) a plurality of registered users, (ii) a plurality of community groups, wherein at least a portion of the registered users are affiliated with one or more community groups, and (iii) a plurality of invitations to make an offer to buy or sell a good or service, wherein each invitation is associated with at least one registered user.

The set of one or more processors may be configured to receive a search input comprising a request from a first registered user to buy or sell a good or service, where the first registered user is affiliated with a first set of one or more community groups. And the set of one or more processors may be configured to also generate a list of one or more invitations in response to the search input. The list of one or more invitations may comprise at least one invitation associated with a registered user that is affiliated with at least one community group of the first set of one or more community groups.

In some embodiments where each registered user is associated with a set of user attributes, and each community group is associated with a set of group attributes, the set of one or more processors may be configured to generate the list of one or more invitations in response to the search input by searching the database of information based on the search input to generate a list of search results. After generating the list of search results, the set of one or more processors may then filter the list of search results. The filter applied to the list of search results may be based on one or more attributes selected from at least one of (i) the user attributes associated with the first registered user, and/or (ii) the group attributes associated with at least one community group of the first set of one or more community groups. In alternative embodiments, the set of one or more processors may be configured to generate the list of one or more invitations in response to the search input by generating a search query comprising the search input and at least one attribute selected from at least one of (i) the user attributes associated with the first registered user, and/or (ii) the group attributes associated with at least one community group of the first set of one or more community groups. After the search query has been generated, the set of one or more processors may use the generated search query to search the database of information.

In some embodiments, the set of one or more processors may be configured to cause the list of one or more invitations to be displayed to the first registered user in a certain order based on preferred community groups, preferred user attributes, or referral network information, as described above.

Another embodiment may comprise a computer readable media having computer-executable instructions stored thereon that, if executed by a computing system, cause the computing system to perform the methods described herein. The computing system may correspond to the systems disclosed and described herein.

### BRIEF DESCRIPTION OF THE FIGURES

FIG. 1 shows a system according one disclosed embodiment

FIGS. 2A-2D show methods according to various disclosed embodiments

### DETAILED DESCRIPTION OF THE FIGURES

In the following detailed description, numerous specific details are set forth in order to provide a thorough understanding of the disclosed systems and methods and how they may be practiced in particular embodiments. However, it will be understood that the systems and methods may be practiced without these specific details. In other instances, well-known methods, procedures and techniques have not been described in detail, so as not to obscure the novel aspects of the disclosed systems and methods. While the disclosed systems and methods will be described with respect to particular embodiments and with reference to certain drawings, the disclosed systems and methods are not limited thereto. The drawings included and described herein are illustrative and do not limit the scope of the invention.

Furthermore, the terms first, second and the like are used for distinguishing between similar elements and not necessarily for describing a sequence, either temporally, spatially, in ranking or in any other manner. It is to be understood that the terms so used are interchangeable under appropriate circumstances and that the embodiments of the systems and methods described herein are capable of operation in other sequences than described or illustrated herein.

The term “comprising” used in the description should not be interpreted as being restricted to the means listed thereafter; it does not exclude other elements or steps. The term should be interpreted as specifying the presence of the stated features, integers, steps or components as referred to, but does not preclude the presence or addition of one or more other features, integers, steps or components, or groups thereof.

Illustrative embodiments will now be described by a detailed description of drawings depicting said embodiments. It is clear that other embodiments of the invention can be configured according to the knowledge of persons skilled in the art without departing from the true spirit or technical teaching of the present disclosure.

A. Exemplary Community Exchange System

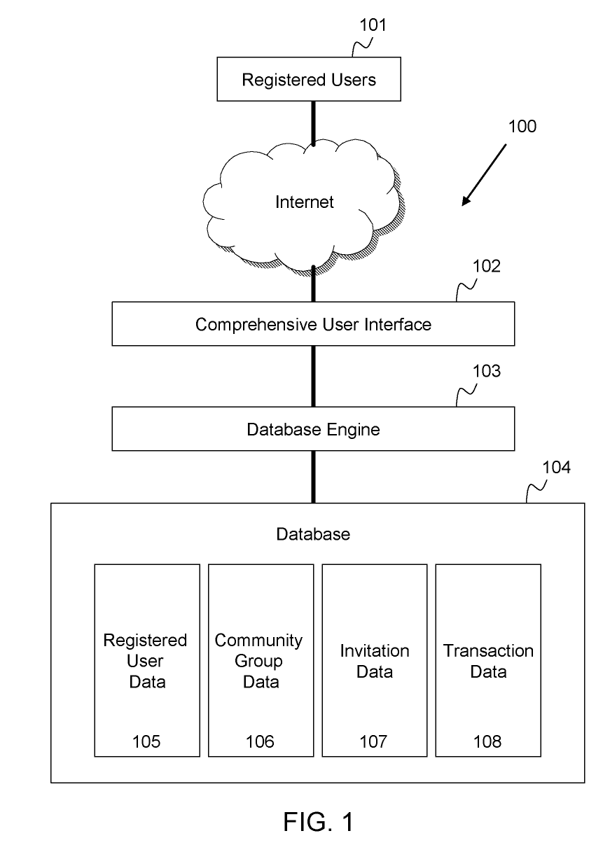

FIG. 1 shows a community exchange system 100 according to one embodiment of the disclosed systems and methods. The community exchange system 100 of FIG. 1 comprises: (1) a database of information 104; (2) a comprehensive user interface 102; and (3) a database engine 103. However, other embodiments of the community exchange system 100 that perform similar functions with different modules, more modules, or fewer modules are envisioned. The database 104, the comprehensive user interface 102, and the database engine 103 are described in more detail below.

1. Database

The database 104 stores and maintains data that facilitates the operation of the community exchange system 100, including: (i) data related to the registered users 101 of the system, (ii) data related to the community groups, (iii) data related to the community group affiliations, (iii) data related to the goods and services offered and pursued by the registered users, and (iv) data related to histories of each registered user's transactions completed through the community exchange system 100. In this manner, the database 104 associated with the community exchange system 100 enables registered users 101 to, among other things, (i) create and post invitations to make offers to buy or sell goods and services, (ii) search for invitations to make offers to buy or sell goods and services, (iii) complete transactions for the purchase and/or sell of goods and services; and (iv) access transaction histories. The data stored in the database 104 is described in more detail below.

The database 104 can be implemented with computer readable media, such as any set of one or more disk drives, disk arrays, or other form of tangible computer readable memory device or devices configured to store the data described herein.

a. Registered User Data

The database 104 stores user attributes associated with the registered users 101 of the community exchange system 100. The registered user data 105 may include user attributes associated with registered users 101 such as, for example, (i) data related to the registered user's contact information, including the registered user's name, physical address, telephone number, email address, personal website, etc.; (ii) data related to the registered user's credentials, including the registered user's skills, experience, education, certifications, licenses, etc.; (iii) data related to the registered user's community group affiliations; (iv) data related to the registered user's ranking in the system as based on longevity of registration, past ratings by other registered users who have completed transactions with the registered user, etc.; (v) data related to the registered user's invitations to make offers to buy or sell goods or services; (vi) data related the registered user's personal referral network; and (vii) data related to all of the registered user's completed transactions. Other user attributes related to registered users may be stored in the database 104 as well.

Any person can register with the community exchange system 100 to become a registered user 101 of the community exchange system 100. Registration with the community exchange system 100 requires the registered user 100 to provide his/her contact information so that other registered users can exchange (i.e. buy and/or sell) goods and services with the registered user.

To sell certain services, registered users may also be required to enter credential information such as the registered user's formal education, the registered user's work experience, the registered user's accreditations and licenses, third-party credential verifications, or other relevant credential information. For example, a registered user who is a dentist may be required to (i) affirm that he or she holds a D.D.S. degree, (ii) specify any school or schools which he or she attended, and (iii) affirm that he or she is accredited and licensed to perform dental services in the relevant geographic area. The registered user may also be required to provide third party verification of the affirmations, such as providing state and/or county license numbers, etc. Other credential information associated with the registered user may be stored by the database 104 as well, depending on the type of product or service being offered.

To gain the full benefits of the community exchange system 100, each registered user 101 should be affiliated with at least one community group, but registered users may affiliate with multiple community groups. In other words, each registered user may be affiliated with a set of one or more community groups. Accordingly, the database 104 stores and maintains data related to each registered user's community group affiliations. Community group data 106 is described in more detail below.

Each registered user can create and post one or more invitations to make an offer to buy or sell goods or services, and each invitation is associated with a registered user. Accordingly, the database 104 includes for each registered user, data related to the registered user's invitations, i.e. invitation data 107. Invitation data 107 is described in more detail below.

Each registered user can exchange goods and services with other registered users. Accordingly, the database 104 includes for each registered user, data related to the registered user's completed transactions, i.e. transaction data 108. Transaction data 108 is described in more detail below.

The registered user data 105 may also include information related to a particular registered user's personal referral network. Each registered user may configure a personal referral network. For example, a first registered user may invite other registered users to join his or her personal referral network, regardless of whether the other registered users are members of the community groups with which the first registered user is affiliated. Similarly, any other registered user can ask to join the first registered user's personal referral network. One registered user may wish to join another registered user's personal referral network for a number of reasons, such as, for example, (i) the registered users may know each other personally or professionally, (ii) the registered users may have transacted business with each in the past, and/or (iii) one registered user may have been referred to a second registered user by a third registered user. Because the quantity of registered users who may join any particular community group might grow to be quite large, a personal referral network can help registered users choose between multiple invitations in a list of invitations. For example, a first registered user may choose to transact business with a particular second registered user because that particular second registered user is either (i) a member of the first selected user's referral network, or (ii) a member of a referral network of another registered user in the first registered user's referral network.

b. Community Group Data

The database 104 also stores community group data 106 related to community groups. Community groups may be formed for any for-profit or non-profit purpose, and any registered user may create a community group for any purpose. Likewise, any registered user may affiliate with (i.e. join) any community group, subject to that particular community group's affiliation requirements. Accordingly, the database 104 stores information about the community groups, and the community group affiliations. This community group data 106 (i.e. group attributes) may include, for at least some community groups, for example: (i) data related to the definition of the community group; (ii) data related to contact information for the registered user (or users) who serve as the community group managers; (iii) data related to the registered users who are affiliated with the community group; and (iv) data related to community group accounting.

Data related to the definition of the community group may include, for example, the name of the community group, the purpose of the community group, and the membership requirements for the community group. Other community group definition data may be stored as well, depending on the type of community group. The community group name, community group purpose, and any community group affiliation requirements are defined by the registered user (or users) who serve as the community group managers.

In one example, a community group may be named the “Main Street Elementary School” community group, and the purpose may be to raise money for the actual Main Street Elementary School located in a particular town. Registered users who wish to affiliate with the “Main Street Elementary School” community group may be required to pledge a percentage of their sales to the “Main Street Elementary School” community group. Various pledge requirements are envisioned. In one model, a community group may require its affiliated registered users to pledge a fixed percentage of all sales to the community group. In another model, a community group may require its affiliated registered users to pledge a percentage of sales made to other members of that community group. Different pledge models may be appropriate in different circumstances depending on the type of community group and the community group's defined purpose.

In another example, a community group may be named the “Movie Industry Group of Los Angeles,” and the purpose may be simply to create a way for workers in the industry to find other movie industry workers for exchanging movie industry related goods and services. Registered users who wish to affiliate with the “Movie Industry Group of Los Angeles” community group may simply be required to (i) have a contact address in the greater Los Angeles area, and (ii) affirm that they work in the movie industry.

As described above, the community group name, community group purpose, and any community group affiliation requirements are defined by the registered user (or users) who serve as the community group managers. Data related to contact information for the registered user (or users) who serve as the community group managers, may include, where applicable, the community group administrator, the community group membership manager, and/or the community group marketing or fundraising manger, etc. The community group administrator may typically be the registered user who created the community group, although a registered user could create a community group and turn over the administration role to a different registered user. The community group administrator is free to delegate various community group management tasks to other registered users. For example, membership management, marketing, fund-raising, and accounting tasks could be delegated to particular registered users who are affiliated with the community group.

An important aspect of any community group is the registered users who are affiliated with the community group. Accordingly, the database 104 stores and maintains data related to the registered users who are affiliated with (i.e., members of) the community group. In addition to a list of registered users affiliated with the community group, data related to the registered users who are affiliated with the community group may also include other attributes related to the community group's affiliated users, such as the total number of affiliated registered users, the average age of the affiliated registered users, the average educational background of the affiliated registered users, the average transaction satisfaction ranking of the affiliated registered users, etc. Many different community group metrics can be compiled and displayed, and any metric based on data stored in the database 104 could be made available for compilation and reporting.

Community group accounting is another important community group metric. Accounting data related to a community group may include monies owed to the community group by its affiliated registered users or monies payable to the community group's related entity where applicable. Other community group accounting data is envisioned as well, such as average and total revenues generated by the registered users who are affiliated with the community group, or the average and total revenues generated by affiliated registered users that are attributable to their affiliation with the community group. As with the other community group metrics, any accounting metric based on data stored in the database 104 could be made available for compilation and reporting.

c. Invitation Data

Invitation data 107 stored in the database 104 associated with the community exchange system 100 may include (i) invitations to make an offer to buy a good; (ii) invitations to make an offer to buy a service; (iii) invitations to make an offer to sell a good; and (iv) invitations to make an offer to sell a service. Invitation Data 107 related to invitations stored in the database 104 associated with the community exchange system 100 may include, for at least some invitations, (i) general information about the good or service, (ii) general information about the registered user providing the good or service, (iii) general information about the group affiliations of the registered user providing the good or service, (iv) and links to more detailed information about the good or service and/or the registered user providing the good or service.

General information about the good or service may include a textual description of the good or service, an audible description of the good or service, and/or a graphical depiction of the good or service, such as a photograph, video, or other visual rendering. Other general information may include the price and/or availability of the good or service. For goods, the price may include the sales price of the good and the availability may include the number in stock and/or the date by which the good could be delivered. For services, the price may include a fixed price or a price per hour, and the availability may include the date and/or time on which the registered user offering the service is available to provide the service.

General information about the registered user providing the good or service may include the name and contact information for the registered user providing the good or service and general information about the community group affiliations of the registered user providing the good or service. General information about the registered user providing the good or service may also include a system rating of the registered user based on (i) any feedback that the registered user has received from other registered users, (ii) the number of transactions that the registered user has completed through the community exchange system 100, (iii) how long the registered user has been registered with the community exchange system 100; (iv) the community groups with which the registered user is affiliated, including an indication of the community group affiliations shared by a prospective buyer and seller; and/or (v) information about the registered user's personal referral network, including an indication of whether the prospective buyer and seller are members of each other's personal referral networks, the extent to which the prospective buyer's/seller's personal referral networks overlap (i.e. the number of shared registered users in their respective personal referral networks), or any other indication that can be determined from each registered user's personal referral network.

Links to detailed information about the good or service and the registered user providing the good or service are important aspects of the invitation as well. The detailed information accessible via the link may include additional basic information, but could also include feature-rich text, audio, graphics, and video data created by the registered user who is offering to buy or sell the good or service. In this manner, the detailed information accessible via the link is akin to a “product pitch,” where the registered user who is offering to buy or sell the good or service can describe the good or service being bought or sold to other registered users.

One example illustrating the “product pitch” aspect of the invitation may be a graduate student in electrical engineering who wishes to offer his or her computer programming skills to software companies on a part-time/contract basis, and also wishes to offer his or her guitar playing skills to bands in the area. The student may register with the community exchange system, and affiliate with a “Software Programmers” community group, a “Java Experts” community group, a “Jazz Musicians” community group, and a “State University” community group.

As a registered user, the student may create an invitation to make an offer to buy computer programming services from the student with a price of $30/hour. The detailed invitation information at the link may include a “storefront-type” page with a description of the programming languages the student is proficient in, the student's prior work experience (and perhaps a copy of the student's resume available for download), a video of the student describing why he or she is a capable programmer, and perhaps links to one or more websites that illustrate the student's programming work. The student may also create an invitation to make an offer to buy jazz guitar services from the student at a price of $15/hr. The detailed invitation information at the link may include a “storefront-type” page with the types of music that the student has played, a video of the student performing in a previous band, a recording of the student's music, a description of the student's guitar and other equipment that the student could bring to a performance, and the student's schedule of availability for playing jazz guitar. Any other registered user data associated with the registered user who created the invitation may be displayed as part of the detailed invitation information at the link as well.

d. Transaction Data

Transaction data 108 may include, for at least some transactions, the parties to the transaction, the date of the transaction, the specific good or service exchanged in the transaction, the price paid for the good or service, a history of the electronic communications between the parties to the transaction, whether the transaction was completed, and any other information related to the transaction. In this manner, historical information related to each transaction can be accessed and reviewed by each party to the transaction.

2. Comprehensive User Interface

The comprehensive user interface 102 is another important aspect of the community exchange system 100. The comprehensive user interface 102 provides a set of interfaces and online tools that enable registered users to facilitate the exchange of goods and services via the community exchange system 100. The comprehensive user interface 102 may be implemented with a set of one or more processors configured to perform various functions associated with the community exchange system 100.

Various configurations of the comprehensive user interface 102 are envisioned. Some embodiments may resemble an “online dashboard” interface with frames to display information to registered users, and control panels to receive inputs from registered users. Other embodiments may resemble a “file-server browser” type of interface with hierarchical lists of links that enable registered users to link to various applications. Some embodiments may enable the registered user to design their own user interface based on the information and inputs the registered user wishes to access on a regular basis. Still other embodiments may include a combination of the above-described layouts. The comprehensive user interface 102 enables registered users 101 to perform a variety of functions related to the exchange of goods and services via the community exchange system 100, regardless of the format that the comprehensive user interface 102 may take.

The comprehensive user interface 102 may include interfaces and tools that enable users to register with the community exchange system 100 to become registered users, edit their registered user profile, and search for other registered users. In this manner, the comprehensive user interface enables a user to input, access, edit, and/or search the above-described registered user data 105 in the database 104. Registering, editing, and updating registered user data may include entering data (name, contact information, etc.) into the community exchange system 100 and uploading files (e.g., resumes, photographs, etc.) to the community exchange system 100.

The comprehensive user interface 102 may also include interfaces and tools that enable a registered user to create new community groups and to join existing community groups. In this manner, the comprehensive user interface enables a user to input, access, edit, and/or search the above-described community group data 106 in the database 104. For example, to create a new community group, the comprehensive user interface 102 enables a registered user 101 to input and edit any of the above-described community group data 106 for a new community group. Similarly, to affiliate with or join an existing community group, the comprehensive user interface 102 enables registered users 101 to search the above-described community group data 106 for existing community groups, and to access information about existing community groups so that the registered user can decide whether to affiliate with a particular community group.

The comprehensive user interface 102 may also include interfaces and tools that enable registered users to create, edit, search for, access, and review invitations to make offers to buy or sell goods or services. In this manner, the comprehensive user interface 102 enables a user to input, access, and/or search the above-described invitation data 107 in the database 104. To create invitations, the comprehensive user interface 102 may include interfaces and online tools for a registered user to specify the type of invitation, to enter a description of the desired good or service, and to enter other information related to the good or service such as the price and/or availability. To edit invitations, the comprehensive user interface 102 may include interfaces and online tools for a registered user 101 to search for or otherwise locate his or her stored invitations, access his or her stored invitations, and change the invitation data of his or her stored invitations.

Searching for invitations is another important aspect of the community exchange system 100. To search for invitations, the comprehensive user interface 102 may include interfaces and online tools that enable a registered user to specify the desired good or service to be searched for. In some embodiments, registered users 101 may also specify a number of other attributes related to invitations, including, for example: (i) the quality level, price-range, etc. of the desired good or service, (ii) the credentials, qualifications, ranking etc. of the registered user associated with the desired good or service, including any preferred user attributes, (iii) the community group or groups where the registered user wishes to buy or sell the desired good or service or any preferred community group attribute, and/or (iv) the community group or groups where the registered user wishes to not buy or sell the desired good or service. Preferred user attributes may correspond to any registered user data associated with registered users, e.g., community group affiliation, geographic location of the user, referral network membership, level of education, etc. Similarly, preferred group attributes may correspond to any community group data associated with a community group. Other criteria could be specified as well, and registered users 101 could use the comprehensive user interface 102 to search for invitations based on any of the data stored in the database 104.

Reviewing invitation search results is another important aspect of the community exchange system 100. To review invitation search results, the comprehensive user interface 102 may include interfaces and tools to enable a registered user 101 to browse a list of invitations generated in response to a search input, sort the list of invitations based on specified criteria, and link to more detailed information about the invitations contained in the list of invitations generated in response to the search input. In this manner, the comprehensive user interface 102 enables a registered user to access any of the above-described invitation data 107 related to a particular invitation that the registered user associated with the invitation has input, uploaded, and/or otherwise authorized other registered users to see.

The comprehensive user interface 102 may also include interfaces and tools that enable registered users 101 to negotiate a transaction, finalize a transaction, track the progress of a transaction, process the payment for a transaction, provide feedback on a transaction or a registered user, and access transaction histories. To negotiate and finalize a transaction, the comprehensive user interface 102 enables registered users to exchange electronic communications with each other as will be described below. The comprehensive user interface 102 includes other interfaces and tools that enable a registered user to track and manage transactions until the good or service is delivered, and the comprehensive user interface enables registered users to process payments for goods and services. The comprehensive user interface 102 also enables registered users to provide feedback on transactions and to access transaction histories, as will be described below.

The comprehensive user interface 102 may also include interfaces and tools that enable registered users to perform other tasks related to the exchange of goods and services via the community exchange system 100.

3. Database Engine

The Database Engine 103 enables the data in the database 104 to be organized and accessed by registered users 101 via the comprehensive user interface 102. The Database Engine 104 may be implemented by a set of one or more processors configured to perform functions related to the community exchange system 100. The set of one or more processors may correspond to one or more general purpose processors, one or more special purpose processors, or any other group of one or more processors configured to perform the identified community exchange system functions described herein.

B. Exemplary Community Exchange Methods

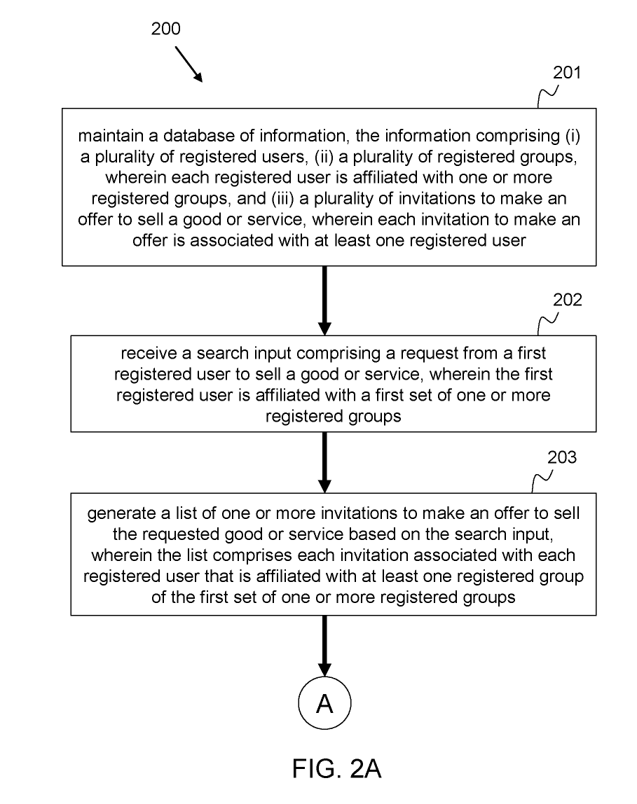

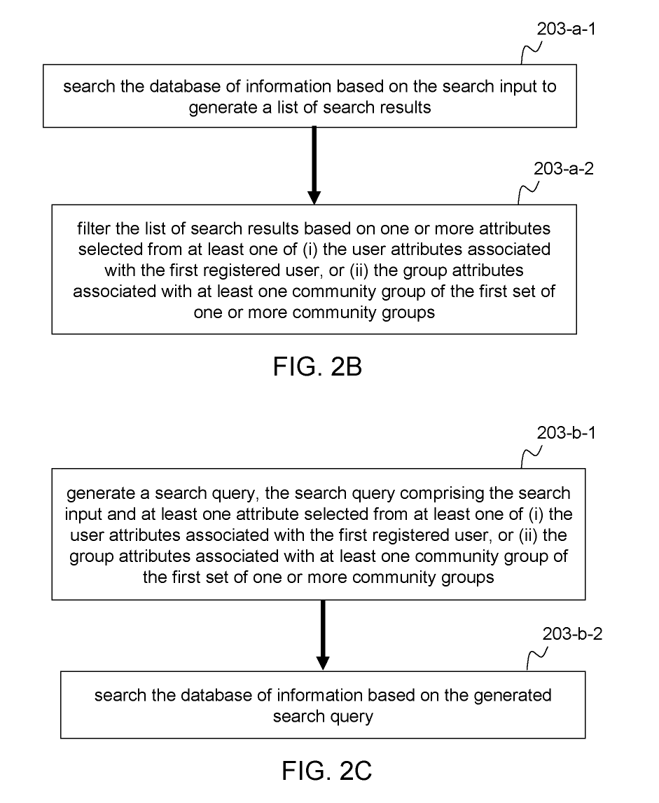

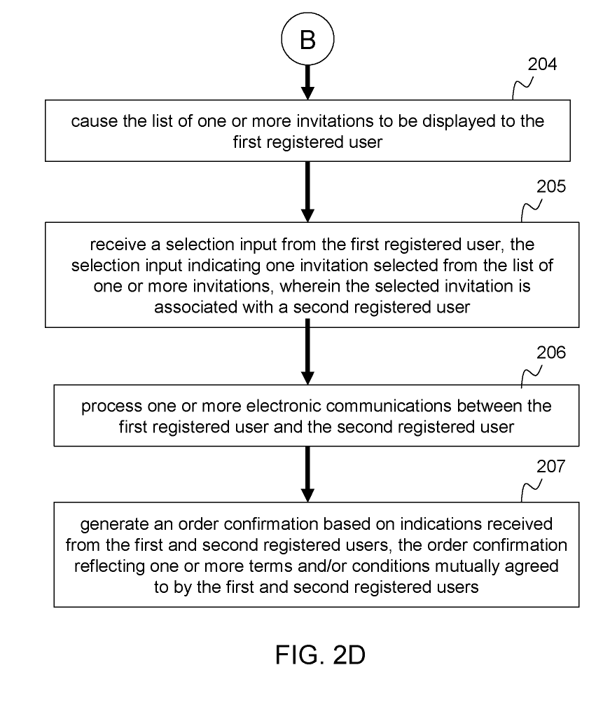

FIG. 2A shows method 200 according to one illustrative embodiment. At step 201, a database of information is maintained on computer readable storage media. The information comprises (i) a plurality of registered users, (ii) a plurality of community groups, wherein at least a portion of the registered users are affiliated with one or more community groups, and (iii) a plurality of invitations to make an offer to buy or sell a good or service, wherein each invitation is associated with at least one registered user. A first registered user who is affiliated with a first set of one or more community groups and who wishes to buy a desired good or service may enter a search input that specifies the desired good or service and perhaps a number of other attributes related to the desired good or service, as described in the present disclosure. At step 202, the first registered user's search input is received, and based on the search input, a list of one or more invitations is generated. The list of one or more invitations comprises at least one invitation associated with a registered user that is affiliated with at least one community group of the first set of one or more community groups.

FIGS. 2B and 2C show alternative ways of generating the list of one or more invitations. At step 203-a-1 in FIG. 2B, a basic search input is used to search the database to obtain a broad list of search results. Then, at step 203-a-2, the broad list of search results is filtered based on one or more attributes selected from at least one of (i) the user attributes associated with the first registered user, or (ii) the group attributes associated with at least one community group of the first set of one or more community groups.

In the embodiment shown in FIG. 2C, a detailed search query is generated, and the detailed search query is used to search the database. First, a detailed search query based on the basic search input is generated at step 203-b-1. The detailed search query comprises the basic search input received from the first registered user and at least one attribute selected from at least one of (i) the user attributes associated with the first registered user, or (ii) the group attributes associated with at least one community group of the first set of one or more community groups. Then, at step 203-b-2, the detailed search query is used to search the database.

In the methods shown in both FIGS. 2B and 2C, the first registered user simply supplies a basic search input, and the community exchange system generates a list of relevant invitations based on (i) the basic search input, (ii) user attributes related to the first registered user, and/or (iii) group attributes related to a set of one or more community groups with which the first registered user is affiliated. By using a user's related user attributes and/or the group attributes of the user's affiliated community groups, a highly relevant list of invitations can be generated through detailed filtering or query construction based on a comparatively simple search input from the registered user.

The list of one or more invitations may include, for a particular invitation, (i) general information about the good or service, (ii) general information about the registered user associated with the invitation, (iii) general information about the group affiliations of the registered user associated with the invitation, (iv) an indication of the community group affiliations (by name or quantity) shared by the first registered user and the registered user associated with the invitation; (v) an indication of whether the registered user associated with the invitation is a member of the first registered user's referral network, (vi) an indication of the number of registered users shared between the referral networks of the first registered user and the registered user associated with the invitation, and/or (vii) links to more detailed information about the good or service and/or the registered user associated with the invitation. Other information related to the invitation, the registered user associated with the invitation, and/or the community groups of the registered user associated with the invitation may be displayed as well.

FIG. 2D shows additional method steps according to one embodiment. At step 204, the community exchange system causes the list of one or more invitations to be displayed to the first registered user. Causing the list to be displayed may include sending data to the first registered user's local computer so that the list can displayed on the first registered user's computer screen.

The list of one or more invitations may be ranked or ordered in a number of ways. For example, in some embodiments, the first registered user may designate one or more community groups as preferred community groups, and invitations associated with registered users who are affiliated with a preferred community group may be displayed higher in the list than invitations associated with registered users who are not affiliated with at least one of the preferred community groups.

In some embodiments, the first registered user may designate one or more user attributes as preferred user attributes, and invitations associated with registered users whose associated user attributes comprise at least one preferred user attribute are displayed higher in the list than invitations associated with registered users whose associated user attributes do not comprise at least one preferred user attribute. For example, a preferred user attribute might be a particular geographic region or zip code where a registered user resides, a particular language spoken by a registered user, a level of education completed by a registered user, a certification or accreditation held by a registered user, whether a registered user is a member of the first registered user's personal referral network, or any of the other registered user data stored in the database. In some instances, for example, invitations associated with registered users who are members of a referral network associated with the first registered user are displayed higher in the list than invitations associated with registered users who are not members of the referral network associated with the first registered user.

At step 205, a selection input is received from the first registered user. The selection input indicates one invitation selected from the list of one or more invitations, and the selected invitation is associated with a second registered user.

The community exchange system includes communications applications that enable the first registered user to communicate with the second registered user via standard electronic communications methods. At step 206, one or more electronic communications are processed between the first registered user and the second registered user. For example, the first registered user may use the communications applications of the community exchange system to (i) send the second registered user an email, (ii) initiate a voice-over-IP call to the second registered user, or (iii) send a text message to the second registered user. Other standard forms of electronic communication could be used as well. The community exchange system stores a record of the electronic communications between the first and second registered users so that both parties have a history of any terms discussed.

After the first and second registered users finalize the terms of the transaction (e.g., firm price, delivery schedule, payment terms, etc. as required for the particular type of transaction), the community exchange system stores the details so that both parties can review and accept the terms and/or conditions of the transaction, thereby creating a contract between the first and second registered users. The community exchange system stores the details of the contract as part of the transaction history so that either party can access the terms and/or conditions later. At step 207, an order confirmation is generated based on indications received from the first and second registered users. The order confirmation may reflect one or more terms and/or conditions mutually agreed to by the first and second registered users.

Once the terms of the contract are finalized, the first and second registered users can use the community exchange system to monitor the status of the transaction (e.g., shipping dates, work schedule, etc.) until the goods or services are delivered. The first and second registered users can also use the community exchange system to exchange further electronic communications to discuss any updates or changes to the transaction, and the community exchange system will store records of the electronic communications between the first and second registered users as part of the transaction history.

After the transaction is completed and the goods or services have been delivered, the community exchange system enables the first and second registered user to store feedback on their transaction experience. For example, the first registered user can provide feedback on the quality of the good or service purchased and/or the ease of working with the second registered user. Similarly, the second registered user can provide feedback on the ease of working with the first registered user and/or whether the first registered user paid for the goods or services as bargained for in the contract. The community exchange system can also store other relevant transaction feedback information depending on the type of transaction and the type of goods or services exchanged between the registered users.

We claim:

1. A method comprising:
maintaining a database of information on computer readable storage media, the information comprising (i) a plurality of registered users, (ii) a plurality of community groups, wherein at least a portion of the registered users are affiliated with one or more community groups, and (iii) a plurality of invitations to make an offer to buy or sell a good or service, wherein each invitation is associated with at least one registered user;
receiving a search input, the search input comprising a request from a first registered user to buy or sell a good or service, wherein the first registered user is affiliated with a first set of one or more community groups; and
generating a list of one or more invitations in response to the search input, the list of one or more invitations generated by one or more processors configured to search the database of information based at least in part on the search input, wherein the list of one or more invitations comprises at least one invitation associated with a registered user that is affiliated with at least one community group of the first set of one or more community groups.

2. The method of claim 1, wherein each registered user is associated with a set of user attributes, wherein each community group is associated with a set of group attributes, and wherein generating a list of one or more invitations in response to the search input comprises:
searching the database of information based on the search input to generate a list of search results; and
filtering the list of search results based on one or more attributes selected from at least one of (i) the user attributes associated with the first registered user, or (ii) the group attributes associated with at least one community group of the first set of one or more community groups.

3. The method of claim 1, wherein each registered user is associated with a set of user attributes, wherein each community group is associated with a set of group attributes, and wherein generating a list of one or more invitations in response to the search input comprises:
generating a search query, the search query comprising the search input and at least one attribute selected from at least one of (i) the user attributes associated with the first registered user, or (ii) the group attributes associated with at least one community group of the first set of one or more community groups; and
searching the database of information based on the generated search query.

4. The method of claim 1, wherein at least one invitation of the list of one or more invitations comprises information about at least one community group affiliation of the registered user associated with the at least one invitation.

5. The method of claim 1, further comprising:
causing the list of one or more invitations to be displayed to the first registered user, wherein invitations associated with registered users who are affiliated with a preferred community group are displayed higher in the list than invitations associated with registered users who are not affiliated with the preferred community group, and wherein the preferred community group is selected by the first registered user.

6. The method of claim 1, wherein each registered user is associated with a set of user attributes, and wherein the method further comprises:
causing the list of one or more invitations to be displayed to the first registered user, wherein invitations associated with registered users whose associated user attributes comprise at least one preferred user attribute are displayed higher in the list than invitations associated with registered users whose associated user attributes do not comprise the at least one preferred user attribute, and wherein the at least one preferred user attribute is selected by the first registered user.

7. The method of claim 1, further comprising:
causing the list of one or more invitations to be displayed to the first registered user, wherein invitations associated with registered users who are members of a referral network associated with the first registered user are displayed higher in the list than invitations associated with registered users who are not members of the referral network associated with the first registered user.

8. The method of claim 1, further comprising:
receiving a selection input from the first registered user, the selection input indicating one invitation selected from the list of one or more invitations, wherein the selected invitation is associated with a second registered user;
processing one or more electronic communications between the first registered user and the second registered user; and
generating an order confirmation based on indications received from the first and second registered users, the order confirmation reflecting one or more terms and/or conditions mutually agreed to by the first and second registered users.

9. The method of claim 1, wherein the affiliation of at least one registered user with at least one community group is based on a pledge by the at least one registered user to give a percentage of sales corresponding to at least one invitation to the at least one community group.

10. A system comprising:
computer readable storage media configured to store a database of information, the database of information comprising (i) a plurality of registered users, (ii) a plurality of community groups, wherein at least a portion of the registered users are affiliated with one or more community groups, and (iii) a plurality of invitations to make an offer to buy or sell a good or service, wherein each invitation is associated with at least one registered user; and
a set of one or more processors configured to (i) receive a search input, the search input comprising a request from a first registered user to buy or sell a good or service, wherein the first registered user is affiliated with a first set of one or more community groups, and (ii) generate a list of one or more invitations in response to the search input, wherein the list of one or more invitations comprises at least one invitation associated with a registered user that is affiliated with at least one community group of the first set of one or more community groups.

11. The system of claim 10, wherein each registered user is associated with a set of user attributes, wherein each community group is associated with a set of group attributes, and wherein the set of one or more processors is configured to generate the list of one or more invitations in response to the search input by (i) searching the database of information based on the search input to generate a list of search results, and (ii) filtering the list of search results based on one or more attributes selected from at least one of (ii-a) the user attributes associated with the first registered user, or (ii-b) the group attributes associated with at least one community group of the first set of one or more community groups.

12. The system of claim 10, wherein each registered user is associated with a set of user attributes, wherein each community group is associated with a set of group attributes, and wherein the set of one or more processors is configured to generate the list of one or more invitations in response to the search input by (i) generating a search query, the search query comprising the search input and at least one attribute selected from at least one of (i-a) the user attributes associated with the first registered user, or (i-b) the group attributes associated with at least one community group of the first set of one or more community groups, and (ii) searching the database of information based on the generated search query.

13. The system of claim 10, wherein at least one invitation of the list of one or more invitations comprises information about at least one community group affiliation of the registered user associated with the at least one invitation.

14. The system of claim 10, wherein the set of one or more processors is configured to cause the list of one or more invitations to be displayed to the first registered user, wherein invitations associated with registered users who are affiliated with a preferred community group are displayed higher in the list than invitations associated with registered users who are not affiliated with the preferred community group, and wherein the preferred community group is selected by the first registered user.

15. The system of claim 10, wherein each registered user is associated with a set of user attributes, and wherein the set of one or more processors is configured to cause the list of one or more invitations to be displayed to the first registered user, wherein invitations associated with registered users whose associated user attributes comprise at least one preferred user attribute are displayed higher in the list than invitations associated with registered users whose associated user attributes do not comprise the at least one preferred user attribute, and wherein the at least one preferred user attribute is selected by the first registered user.

16. The system of claim 10, wherein the set of one or more processors is configured to cause the list of one or more invitations to be displayed to the first registered user, wherein invitations associated with registered users who are members of a referral network associated with the first registered user are displayed higher in the list than invitations associated with registered users who are not members of the referral network associated with the first registered user.

17. A computer readable media having computer-executable instructions stored thereon that, if executed by a computing system, cause the computing system to perform a method comprising:
maintaining a database of information, the information comprising (i) a plurality of registered users, (ii) a plurality of community groups, wherein at least a portion of the registered users are affiliated with one or more community groups, and (iii) a plurality of invitations to make an offer to buy or sell a good or service, wherein each invitation is associated with at least one registered user;
receiving a search input, the search input comprising a request from a first registered user to buy or sell a good or service, wherein the first registered user is affiliated with a first set of one or more community groups; and
generating a list of one or more invitations in response to the search input, wherein the list of one or more invitations comprises at least one invitation associated with a registered user that is affiliated with at least one community group of the first set of one or more community groups.

18. The computer-readable media of claim 17, wherein each registered user is associated with a set of user attributes, wherein each community group is associated with a set of group attributes, and wherein generating a list of one or more invitations in response to the search input comprises:
searching the database of information based on the search input to generate a list of search results; and
filtering the list of search results based on one or more attributes selected from at least one of (i) the user attributes associated with the first registered user, or (ii) the group attributes associated with at least one community group of the first set of one or more community groups.

19. The computer-readable media of claim 17, wherein each registered user is associated with a set of user attributes, wherein each community group is associated with a set of group attributes, and wherein generating a list of one or more invitations in response to the search input comprises:
generating a search query, the search query comprising the search input and at least one attribute selected from at least one of (i) the user attributes associated with the first registered user, or (ii) the group attributes associated with at least one community group of the first set of one or more community groups; and
searching the database of information based on the generated search query.

20. The computer-readable media of claim 17, wherein each registered user is associated with a set of registered user attributes, and wherein the method further comprises:
ranking the list of one or more invitations, wherein invitations associated with registered users who are affiliated with a preferred community group are ranked higher than invitations associated with registered users who are not affiliated with a preferred community group, and wherein the preferred community group is selected by the first registered user, wherein invitations associated with registered users whose corresponding user attributes comprise at least one preferred user attribute are ranked higher than invitations associated with registered users whose corresponding user attributes do not comprise the at least one preferred attribute, and wherein the preferred user attribute is selected by the first registered user, and wherein invitations associated with registered users who are members of a referral network associated with the first registered user are ranked higher than invitations associated with registered users who are not members of the referral network associated with the first registered user; and
causing the list of one or more invitations to be displayed to the first registered user in ranked order.
